(19) United States
(12) Patent Application Publication
(10) Pub. No.: US 2001/0037270 A1
(43) Pub. Date: Nov. 1, 2001

(54) System and method of providing invoice information

(76) Inventors: William Melo, Simi Valley, CA (US); Ladon Harrison, Moorpark, CA (US); Gregory Strockbine, Canoga Park, CA (US); Frederick Class, Moorpark, CA (US); LLoyd Manglapus, Chatsworth, CA (US); James Keeler, Thousand Oaks, CA (US); Alistair Egan, Oxnard, CA (US)

Correspondence Address: Eric S Chen, Pillsbury Winthrop LLP, Suite 2800, 725 South Figueroa Street, Los Angeles, CA, 90017-5406, US

(21) Appl. No.: 09/784,648

(22) Filed: Feb. 15, 2001

Related U.S. Application Data
(63) Continuation-in-part of application No. 09/557,839, filed on Apr. 26, 2000.

(51) Int. Cl. G06F 17/60

(52) U.S. Cl. 705/34

(57) ABSTRACT

The disclosed system and method provides an invoice to a customer for the use of a device by the customer. Information representative of an amount of usage of the device by the customer is recorded and maintained. A process associated with a billing party is coupled to the device through a data communication network. An invoice is provided to a billing destination at a premises of the customer on a human-readable medium having an invoice amount based upon the amount of usage of the device by the customer and pre-established billing contract rules.

### RELATED APPLICATION DATA

This application is a continuation-in-part of U.S. patent application Ser. No. 09/557,839, filed Apr. 26, 2000.

### BACKGROUND OF THE INVENTION

1. Field of the Invention

Embodiments described herein relate to equipment used by customers. In particular, these embodiments relate to equipment for use by customers for a fee.

2. Discussion of the Related Art

In a modern office environment, an enterprise typically employs several office machine devices including printers, photocopiers and facsimile machines. Other enterprises may employ industrial devices for use in a manufacturing facility or in field operations. Rather than purchase these devices, enterprises have opted for leasing through a finance company. Here, a dealer or servicing agent provides these devices to the enterprise and arranges for a third party finance company to underwrite a lease for the use of the devices.

The terms of lease of the devices typically involves providing the customer with an invoice on a periodic basis (such as once per month). The amount of the invoice is typically based upon an amount of usage of the office equipment during the billing period. For example, an invoice amount may include a fixed cost component in addition to a sum based upon the measure of usage of the office equipment over the billing period. For a printer or a copy machine, the amount of usage may be based upon the number of sheets printed as maintained by counters internal to the printer or photocopier machine. For a facsimile machine, such usage may be determined based upon a number of pages scanned or transmitted as maintained by counters internal to the facsimile machine.

To prepare a written invoice for a customer, a billing party (e.g., the finance company or the dealer/servicing agent acting on behalf of the finance company) typically travels to the customer's site to inspect the leased office equipment to read out usage information from the display panel or counter cartridges. Based upon the usage information read out from the equipment at the customer's premises, the billing party typically prepares a written invoice to the customer. There is a need for a less cumbersome and cost efficient method of providing an invoice to a lessee of office equipment based upon how much the lessee has used the office equipment over the billing period.

### BRIEF DESCRIPTION OF THE DRAWINGS

FIG. 1 shows a topology of a communication network coupling devices at a customer premises with one or more processes associated with a billing party;

FIG. 2 illustrates steps in providing an invoice to a customer premises according to an embodiment in which a process associated with a billing party transmits a polling signal;

FIG. 3 illustrates steps in providing an invoice to a customer premises according to an embodiment in response to receipt of a print job from a billing party; and

FIG. 4 illustrates steps in providing an invoice to a customer premises by determining an invoice amount at a device at the customer premises.

### DETAILED DESCRIPTION

An embodiment of the present invention is directed to providing an invoice to a customer for the use of a device based upon usage information maintained in conjunction with the device. The device may be coupled to a process associated with a billing party through a data communication network. In one embodiment, the device may transmit information to the process associated with the billing party indicative of an amount of usage of the device over a billing period. In response to receiving usage information, the process associated with the billing party may determine an invoice amount and initiate the printing of an invoice at a billing destination. In another embodiment, the device determines an invoice amount based upon the usage information and causes an invoice with the invoice amount to be printed.

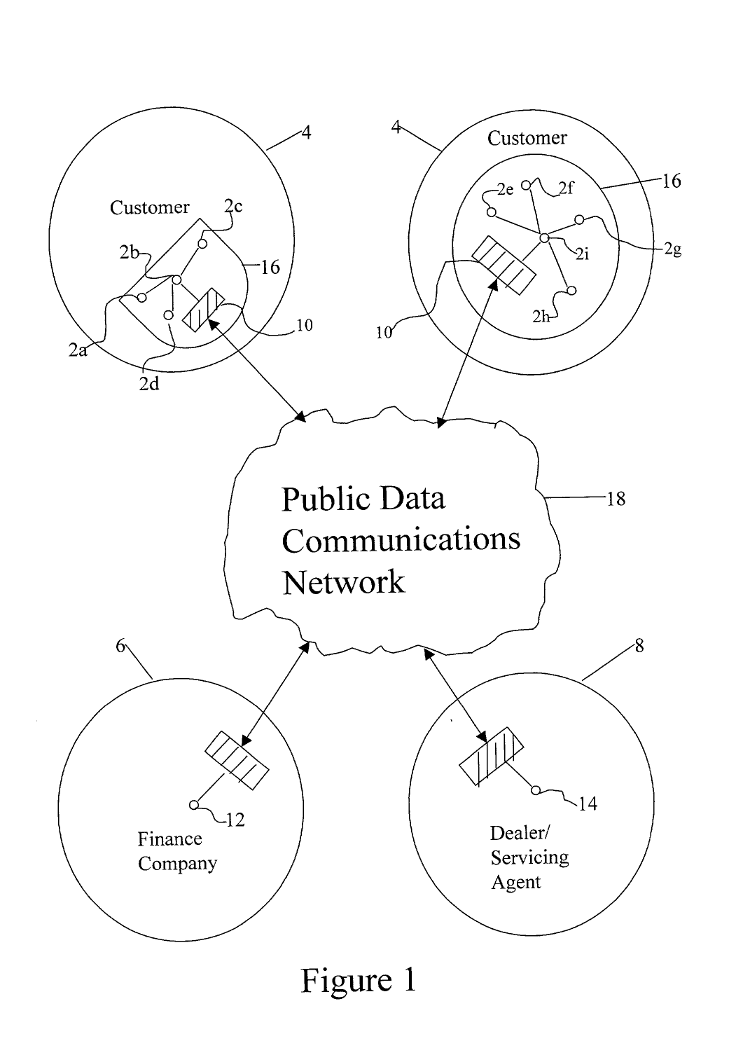

FIG. 1 shows a topology of a network coupling a customer with a finance company 6 and a dealer or servicing agent 8. It should be understood that the finance company 6 and the dealer or servicing agent 8 may be the same party. A customer premises 4 includes one or more devices 2 coupled to a data communications network 18. In the case where the customer premises is as an office environment, the devices 2 may be devices such as, among other things, a printer, copy machine, facsimile machine, or other device which may be used by a customer at the customer premises 4. In other embodiments, a device 2 may be a mechanical or industrial device for use by a customer in a manufacturing plant, in field operations or a residence. Additionally, the device 2 may be located off of a customer's premises and coupled to a data communication network via a hardwired or wireless link. A dealer/servicing agent 8 may include entities which are contracted to service or maintain one or more of the devices 2. A finance company 6 may include entities which are in the business of purchasing devices 2 which are then leased to the customers for use. Such lease terms may specify periodic payments to be made by the customer to the finance company 6 either directly or through the dealer/servicing agent 8. Here, the customer may receive a periodic statement providing an invoice amount for the lease during a relevant billing period, and may indicate how the invoice amount was determined. In one embodiment, the invoice amount for the lease of any particular device 2 may be based upon a measure of usage of the particular device 2 over the relevant billing period.

FIG. 1 shows that devices 2 at a customer premises 4 may be coupled together in a local area network (LAN) 16. Each LAN 16 includes a firewall 10 which enables communication between the devices 2 and other nodes in a public data communication network 18 such as the Internet. Similarly, the dealer/servicing agent 8 and the finance company 6 may also have hosts 14 and 12 which are capable of communicating with devices coupled to the public data communications network 18. It should be understood that other suitable public or private data communication networks, and combinations of public and private networks, may be used to facilitate communication between and among the hosts 12 and 14, and the devices 2.

In the illustrated embodiment, the devices 2 may include circuitry and/or logic for maintaining information representative of a measure of usage of the device over the billing period. For example, in the case where the device 2 is a printer or a photocopier, such circuitry and logic for maintaining usage information may include circuitry or logic for counting a number of pages printed or processed. In the case where the device 2 is a facsimile machine or scanner, such usage information may be provided by circuitry or logic for maintaining a count of the number of pages scanned or transmitted. The devices 2 may also include a network controller capable of supporting communication through an Ethernet port coupled to the LAN 16. In alternative embodiments, the devices 2 may be coupled in the LAN 16 with wireless links. The Ethernet controller may allow the devices to be configured to perform as Internet devices according to an Internet Protocol (IP). The devices 2 may also include a print engine for transferring images to media sheets in response to signals from a printer controller. In one embodiment, the printer controller may also maintain the information quantifying the measure of usage over the billing period and may communicate with external processes through the network controller.

In an alternative embodiment, a controller (not shown) external to the device 2 may maintain the usage information. For example, the device 2 may transmit a signal to the external controller upon usage events. In the case where the device 2 is a printer or a photocopier, the device 2 may transmit a signal to the external controller indicating incremental units of usage, such as the printing of a page or sheet of a document.

In an embodiment in which a device 2 can provide an image on a human readable medium (e.g., a printer copier or facsimile machine), the device 2 may receive print jobs at a network controller through an Ethernet port. Such print jobs may include a print job header, and print data including image data and image controller commands. Such image controller commands may be formed according to a PostScript or Page Description Language (PDL) providing a printer job language (PJL). In one embodiment, particular devices 2 may be configured to receive and process print jobs transmitted to the device 2 according to the Internet printing protocol (IPP) as described in the IPP specifications Model and Semantic/1.1; and Encoding and Transport published by the Printer Working Group of the Internet Engineering Task Force (IETF) on Mar. 1, 2000. In another embodiment, particular devices 2 may include a telephone modem enabling communication to either the finance company 6 or the dealer/servicing agent 8 through a point to point dial-up connection.

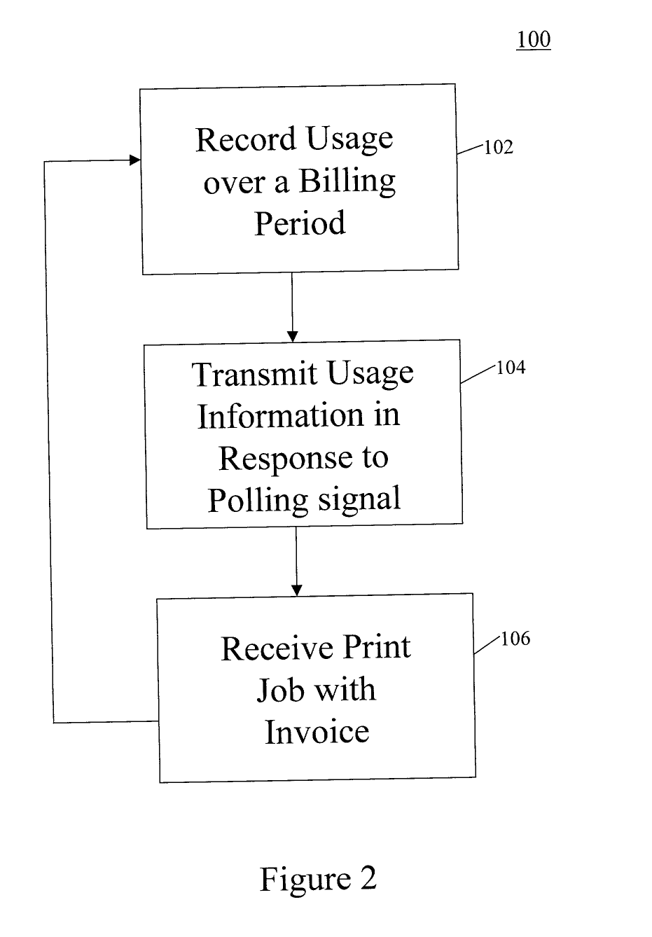

In the presently illustrated embodiment, the host 12 at the finance company 6 and the host 14 at the dealer/servicing agent 8 may execute one or more processes for communicating with individual devices 2 to the public data communication network 18 using one or more protocols supported by the public data communication network 18. The finance company 6 or dealer/servicing agent 8 may individually or collectively serve as a “billing party” which maintains information related to periodic invoices to be provided to the customers for usage of one ore more of the devices 2. As discussed below, processes associated with the billing party (e.g., processes executing on one or more of the hosts 12 and 14) may interact with the devices 2 for the automated generation of human readable invoices (e.g., printed from or displayed at the devices 2) at the customer premises 4. FIGS. 2 through 4 illustrate embodiments of the present invention directed to such automated generation of invoices at devices 2.

FIG. 2 illustrates an embodiment which processes associated with the billing party transmit a polling signal to one or more of the devices 2. At step 102, a record of usage of the device 2 over a billing period is maintained at the device 2 or at an external controller. For example, in the embodiment in which the device 2 is a printer or photocopier, a record of the number of pages processed or printed out over a billing period by a print engine of the device 2 may be maintained in a memory. A network controller and/or printer controller at the device 2 or external controller may be configured to host an agent process such as a simple network management protocol (SNMP) agent defining the usage information as an SNMP object. The processes associated with the billing party may be configured to provide an SNMP manager which transmits the polling signal to the device in the form of an SNMP request. At step 104, in the currently illustrated embodiment, the SNMP agent responds to the SNMP request by accessing the recorded usage information defined as an SNMP object and transmitting the usage information back to the SNMP manager (of the processes associated with the billing party) in the form of an SNMP response.

In an alternative embodiment, a proxy server (not shown) on a platform located near the device 2 provides the SNMP manager for collecting usage information for one or more devices 2, for one or more customers. The usage information for the devices 2 may then be transmitted to a server at the location of the billing party in a single transmission.

Upon receipt of the usage information, the processes associated with the billing party may determine an invoice amount based upon the received usage information. The processes associated with the billing party may then form print job addressed to one or more billing destination at each customer premises 4 including an invoice amount. The billing destination may be the same device 2 or a different device 2 which is specifically designated for providing printed invoices. The billing destination receives the print job with the invoice document at step 106. Alternatively, the process associated with the billing party may print out a hard copy invoice document to be mailed to the customers, or transmit an invoice document to the customer in an electronic mail message or by facsimile transmission.

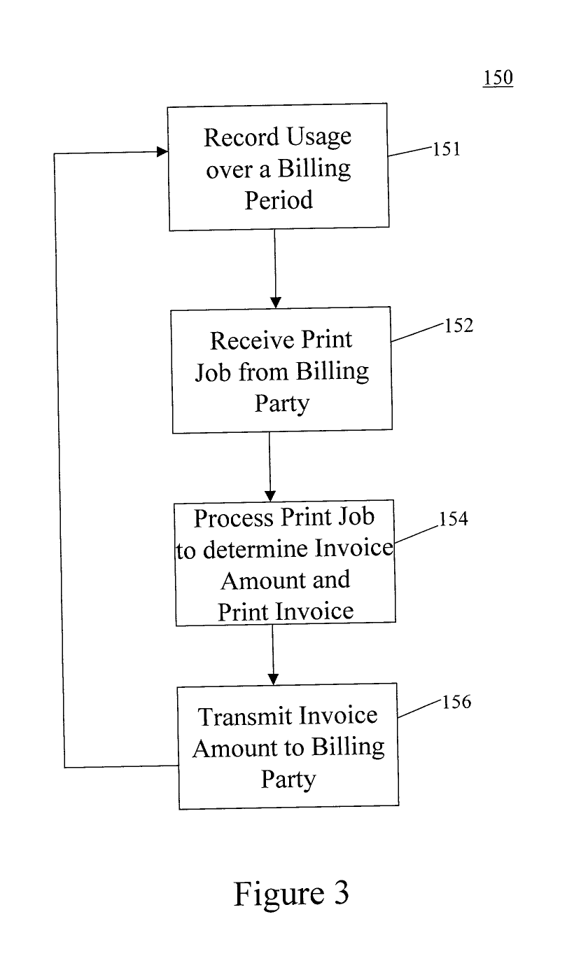

FIG. 3 illustrates an alternative embodiment in which processes associated with the billing party transmit a print job to the device 2 without first transmitting a polling signal. At step 151, the device 2 or external controller maintains a record of usage information over a billing period in a memory. At set billing intervals, processes associated with the billing party may transmit print jobs for invoice documents to either the device 2 or the external controller. These print jobs may include image controller commands interpretable by a printer controller at the device 2 or external controller for accessing the recorded usage information and calculating an invoice amount using an algorithm encoded in the image controller commands. The image controller commands may then define an insertion of the determined invoice amount into the printed invoice document of the print job in combination with other form information on the invoice document. Accordingly, upon receipt of the print job from the billing party at step 152, the image controller at step 154 processes the print job to determine an invoice amount and to print the invoice document with the calculated invoice amount at the device 2, external controller, or other device capable of providing the customer with a printed invoice document. Additional image controller commands in the print job may also instruct the printer controller to transmit the invoice amount back to the processes associated with the billing party through the public data communication network 18.

In an alternative embodiment, a device at a billing destination distinct from the device 2 receives a print job at step 152. The device at the billing destination interprets the image controller commands to retrieve the usage information from the device 2 or external controller through a data network, calculate the invoice amount based upon the retrieved usage information and print the invoice document (step 154), and transmit the invoice amount back to the billing party (step 156).

The printer controller may be configured to interpret image controller commands for accessing the usage information, determining the invoice amount and transmitting data back to the processes associated with the billing party may be encoded into PJL commands as illustrated in U.S. patent application Ser. No. 09/138,962 entitled “Network Printing System”, filed on Aug. 24, 1998, and incorporated herein by reference.

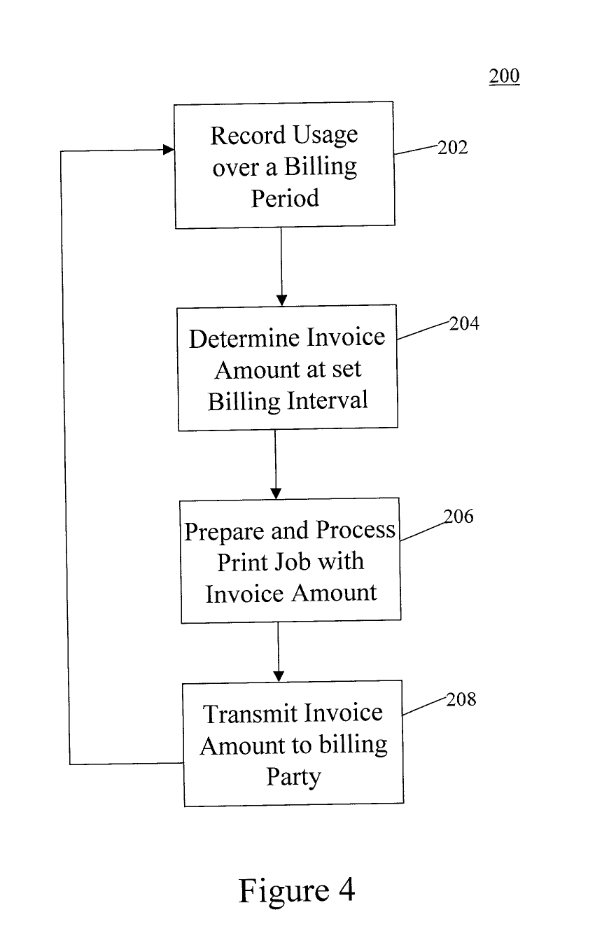

FIG. 4 is directed to an embodiment in which a device 2 may independently provide a printed invoice may be provided without receiving information from processes associated with the billing party. Here, the device 2 or external controller maintains a record of a usage of the device 2 over a billing period at step 202. At set billing intervals encoded in an agent process at the device 2 or external controller, the agent process determines 204 an invoice amount based upon the stored information indicating usage of the device 2 over the billing period. The agent process then prepares a print job of an invoice document with the invoice amount at step 206. The device 2 or external controller may then process the print job to provide a printed invoice document. In an alternative embodiment, the device 2 or external controller may, instead of processing the print job, transmit the print job to a billing destination at the customer premises 4, to a printer at the billing party or other printer. At step 208, the agent process may transmit an invoice amount to processes associated with the billing party either through an Ethernet port coupled to a LAN 16 and the public data communication network 18, or through a point-to-point dial-up connection with a telephone modem.

The embodiments illustrated above with reference to FIGS. 2 through 4 provide a printed invoice document at a billing station at the customer premises 4. Alternatively, the readable invoice document may be provided in an electronic display in addition to, or in lieu of, providing a hard printed invoice document. As discussed above, the invoice amount may be based upon an amount of usage of the device over a specified billing period. A total invoice amount may also include various cost components such that the total invoice amount may be determined by, for example, combining one or more cost components based upon the amount of the usage over the billing period with other cost components.

According to an embodiment, the device 2 or external controller may maintain usage information associated with specific billing accounts. For example, a customer may have several organizations or departments which share the costs of providing the devices 2 at the customer premises 4. Here, the costs of providing the devices 2 at the customer premises 4 may be allocated among the organizations or departments. In another embodiment, the customer may be a service organization providing service to one or more clients on a matter by matter basis (e.g., a law firm providing services to clients for particular matters).

The devices 2 or external controllers may be programmed to maintain usage information for particular accounts associated with either an organization or department of the customer, or particular matters for clients. The total invoice amount (as determined by processes associated with the billing party or logic at the devices at step 154 of FIG. 3 or step 204 of FIG. 4) may be broken down into cost components associated with the specific accounts. The customer may then apply these cost components against budgets associated with the organizations or departments of the customer, or applied to invoices to clients for specific matters.

According to an embodiment, in which the total invoice amount associated with the usage of a device 2 is decomposed into specific cost components allocated to different accounts, the customer may tailor how these costs components are to be allocated among the different accounts. For example, in the instance where the total invoice amount is determined at the device 2 or external controller, the device 2 or external controller may be programmed to allocate the costs associated with total invoice amount to the different accounts using a method specified by the customer. Alternatively, the customer may specify to the billing party that the total invoice amount is to be allocated among the different accounts according to a formula provided by or selected by the customer.

According to an embodiment, a device 2 or external controller may include a control and display portion which enables a user to access stored billing on usage information. The device 2 or external controller may be programmed to provide billing information to a user at the display. Here, a user may be provided with a password which enables access to privileged billing information. The device 2 or external controller may then provide invoice amounts from past billing periods to the display. Alternatively, the device 2 or external controller may determine an invoice amount based upon usage to date in the current billing period, and provide that invoice amount to the display.

As illustrated above, one or more of the embodiments of the devices 2 or external controllers may transmit an amount of usage associated with the device 2 to processes associated with the billing party. In an embodiment in which the billing party includes the dealer/servicing agent 8, the usage information transmitted by the device 2 may enable the dealer/servicing agent to schedule regular maintenance servicing, or replacement of the devices 2 based upon the degree of usage over the life of the device 2. This could enable the dealer/servicing agent to manage inventories associated with expendables (e.g., print toner, etc.) and automatically order supplies from suppliers over the Internet 18.

According to a further embodiment, the system, device 2, and method of providing billing information to a customer may include circuitry, logic, or step to provide the invoice amount based upon the usage information and pre-established billing contract rules, from, for example, a lease agreement, as mentioned above. That is, the finance or leasing company provides the terms of a lease agreement or contract for the system or device 2 being leased, to which the costs of the lease are tied. For example, a term of a contract for the lease of a copier or printing system may indicate that an average of four percent toner coverage per page is allowable in a billing period or cycle, and an excess of four percent will incur additional charges. An algorithm or formula may be provided to determine the percentage of toner coverage utilized for each page, and an average percentage utilized may be determined for each billing period. A formula may also be provided to determine the additional charges to be assessed. Accordingly, the invoice amount at the end of a billing period is determined utilizing the usage information, and then adjusting the invoice amount based upon the pre-established billing contract rules, such as adding additional charges if the average toner coverage per page exceeded four percent during the billing period, as in the above example. Additionally, rather than adjusting the invoice amount, the usage information may be adjusted instead based on the pre-established billing contract rules so that it will produce an invoice amount that takes into consideration the pre-established billing contract rules.

Other types of adjustments based upon pre-established billing contract rules may be performed as well, such as providing “service credits” to “test pages” used during service of the system or device 2 (i.e., reducing the usage information or invoice amount by the number of “test pages” utilized during service of the system); or adjustments based on the media types utilized (e.g., billing five “clicks” for a sheet of heavy paper utilized, as heavier papers create more wear on the printer or copier). A pre-established billing contract rule or lease term may also provide that no more than five percent of all the printouts generated may be of heavy stock media, and that any excess over the five percent will incur additional charges. A “click” may represent a “standard” printout, such as a no-greater-than-four-percent toner coverage, 20-weight, letter-sized page; but any other criteria may be utilized. Accordingly, in the example provided, a printout on a specific type of heavy stock media may each count as if five sheets of a “standard” printout page was generated, and the usage information or invoice amount would be adjusted accordingly.

Alternatively, the lease or contract may provide that if less than an average of, for example, four percent toner coverage per page was utilized during a billing period, or that less than five percent of all printouts during the billing period were of heavy stock media, the usage information or invoice amount may be adjusted downward (i.e., reduced), to reflect the less toner actually utilized, the less wear actually incurred on the printer/copier, etc., in order to pass on the “savings” to the customer. Any criteria for adjusting upward or downward may be provided with the pre-established billing contract rules, and the pre-established contract rules may provide only upward or downward adjustments, or both. By providing the invoice amount based upon usage information and pre-established billing contract rules, the invoice amount more accurately reflects the actual usage of a system or device 2 by the customer and the terms agreed upon for the usage. The usage information or invoice amount are preferably adjusted by the system or device 2, where the ultimate invoice amount may be readily provided to the customer.

While there has been illustrated and described what are presently considered to be the preferred embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A system of providing billing information to a customer comprising:
circuitry to maintain usage information representative of cumulative customer usage associated with a device over a time period; and
processes associated with a billing party for transmitting a print job through a data communication network to a billing destination at a premises of the customer including commands for printing an invoice amount based upon the usage information and pre-established billing contract rules.

2. The system of claim 1, wherein the device is coupled to the data communication network and the processes associated with the billing party transmit a poll signal through the data communication network to the circuitry to maintain the usage information,
wherein in response to a receipt of the poll signal, the circuitry to maintain the usage information transmits data representative of the cumulative customer usage to the processes associated with the billing party, and
wherein in response to receipt of the data at the processes associated with the billing party, the billing party determines the invoice amount based upon the usage information and the pre-established billing contract rules.

3. The system of claim 1, wherein the billing destination is the device and the print job includes commands interpretable at the device encoded therein for:
retrieving the usage information from a memory associated with the device; and
determining the invoice amount based upon the retrieved usage information and the pre-established billing contract rules.

4. The system of claim 1, wherein the circuitry to maintain the usage information is in a controller external to the device and the billing destination is the external controller.

5. The system of claim 1, wherein the circuitry to maintain the usage information maintains information indicating usage for distinct accounts defined by the customer and wherein the invoice amount indicates a total invoice amount and portions thereof applied to each of the accounts.

6. The system of claim 1, wherein the invoice amount is based upon a plurality of combined cost components, at least one of the cost components being based upon the usage information.

7. The system of claim 1, wherein the billing party is one of an entity financing a lease of the device to the customer and an entity which is contracted to service the device.

8. The system of claim 1, wherein the billing party is an entity contracted to service the device and the processes associated with the billing party determines a service schedule based upon the usage information.

9. A device at a premises of a customer, the device comprising:
circuitry to maintain usage information representative of cumulative customer usage associated with the device over a time period; and
logic to determine an invoice amount based upon the usage information and pre-established billing contract rules;
logic to generate a print job of a document including the invoice amount for processing at a print engine associated with the device; and
logic to transmit data representative of the invoice amount to processes associated with a billing party.

10. The device of claim 9, wherein the logic to transmit data representative of the invoice amount is configurable to transmit the invoice amount to processes associated with the billing party through a data communication network.

11. The device of claim 9, wherein the logic to transmit data representative of the invoice amount is configurable to transmit the invoice amount to processes associated with the billing party through a phone modem.

12. The device of claim 9, wherein the device maintains information indicating usage for distinct accounts defined by the customer and wherein the invoice amount indicates a total invoice amount and portions thereof applied to each of the accounts.

13. The device of claim 9, wherein the invoice amount is based upon a plurality of combined cost components, at least one of the cost components being based upon the usage information.

14. The device of claim 9, wherein the billing party is one of an entity financing a lease of the device to the customer and an entity which is contracted to service the device.

15. The device of claim 9, wherein the billing party is an entity contracted to service the device and the processes associated with the billing party determine a service schedule based upon the usage information.

16. A method of providing billing information to a customer, comprising:
maintaining usage information representative of cumulative customer usage associated with a device over a time period; and
transmitting a print job from processes associated with a billing party through a data communication network to a billing destination associated with the customer, the print job including commands for printing an invoice amount based upon the usage information and pre-established billing contract rules.

17. The method of claim 16, wherein the device is coupled to the data communication network, the method further including:
transmitting a poll signal from the processes associated with the billing party to the device through the data communication network;
in response to a receipt of the poll signal, transmitting data representative of the cumulative customer usage from the device to the processes associated with the billing party; and
determining the invoice amount at the billing destination based upon the usage information in response to receipt of the data at the processes associated with the billing party, the billing party determining the invoice amount based upon the usage information and the pre-established billing contract rules.

18. The method of claim 16, wherein the billing destination is the device and the print job includes commands interpretable at the device encoded therein for:
retrieving the usage information from a memory associated with the device; and
determining the invoice amount based upon the retrieved usage information and the pre-established billing contract rules.

19. The method of claim 16, the method further comprising maintaining information indicating usage for distinct accounts defined by the customer and wherein the invoice amount indicates a total invoice amount and portions thereof applied to each of the accounts.

20. The method of claim 16, the method further comprising determining the invoice amount based upon a combination of cost components, at least one of the cost components being based upon the usage information.

21. The method of claim 16, wherein the billing party is one of an entity financing a lease of the device to the customer and an entity which is contracted to service the device.

22. The method of claim 16, wherein the billing party is an entity contracted to service the device and the processes associated with the billing party determines a service schedule based upon the usage information.

23. The method of claim 16, wherein the usage information is maintained at circuitry in the device.

24. The method of claim 16, wherein the usage information is maintained at a controller which is external to the device.

25. The method of claim 16, wherein the method further includes:
transmitting the usage information from one of the device and a controller external to the device to a proxy server associated with the billing party;
receiving the usage information relating to one or more devices at the proxy server; and
transmitting the usage information received at the proxy server to the processes associated with the billing party.
